(19) United States
(12) Patent Application Publication
(10) Pub. No.: US 2008/0223958 A1
(43) Pub. Date: Sep. 18, 2008

(54) Paint spray gun with suspension bracket attachment

(76) Inventors: Danuta Helena Carey, Stockholm, NJ (US); Christopher Michael Walsh, Florham Park, NJ (US); John Michael Plocic, Sparta, NJ (US); John Richard Crane, Rahway, NJ (US)

Correspondence Address: BUCKNAM AND ARCHER, 1077 NORTHERN BOULEVARD, ROSLYN, NY, 11576, US

(21) Appl. No.: 11/716,061

(22) Filed: Mar. 12, 2007

(51) Int. Cl. B05B 7/02

(52) U.S. Cl. 239/526

(57) ABSTRACT

A paint spray gun with suspension bracket attachment is provided whereby the spray gun can be easily and quickly suspended by the painting operator from a ladder rung, scaffold railing, pipe, bar or other structural element by the suspension bracket during the painting operation when the spray gun is temporarily not in use.

### FIELD OF THE INVENTION

The present invention relates generally to paint spray guns and, more particularly, to a paint spray gun including a suspension bracket attachment which renders the spray gun more practicable in use by permitting the spray gun to be suspended or hung from ladders, scaffolds, pipes, bars and other structural elements when temporarily not in use.

### BACKGROUND OF THE INVENTION

Paint spray guns are generally if not always provided with a relatively small hook located along the top of the barrel portion of the spray gun. This small hook can be used to hang or suspend the spray gun from a wire or a nail or some such similar object when the spray gun is not in use. Also, at least with respect to hydraulic or airless paint spray guns, during cleaning the gun is suspended from the small hook on the rim of a large cleaning bucket while water is flushed through the gun.

However, for painting professionals involved in painting large structures such as buildings, tanks, water towers, bridges, ships, etc.; the small hook provided on spray guns is not very convenient for the operator who may be on a scaffold or ladder during the painting operation. The small hook provided with the spray gun is too small to permit hanging or suspending the gun from a convenient member or part of a ladder or scaffold. In such cases it is necessary for the painting operator, while mounted on a scaffold or ladder, to carry with him some other device for attachment to the scaffold or ladder from which the spray gun can be temporarily suspended by its small hook. Otherwise, it is necessary for the painting operator to physically carry the spray gun and its hose attachments, which may be 50 to 100 feet in length and weigh ten pounds or more, each time he removes himself from the scaffold or ladder for whatever reason. This is not only tiresome and an inconvenience to the painting operator but it also increases the time required for the painting operation thereby adding to the overall cost thereof.

### SUMMARY OF THE INVENTION

It is a primary object of the present invention to provide an improved paint spray gun which facilitates the hanging or suspending of the spray gun from the normal equipment or structures found at the painting operation site by a painting professional.

The above object is accomplished in accordance with the present invention by providing a paint spray gun with a suspension bracket attachment which is large enough to engage a ladder rung, scaffold railing, pipe, bar or other structural element found at construction sites and thereby permit the spray gun to be suspended therefrom by the painting professional when temporarily not in use.

### BRIEF DESCRIPTION OF THE DRAWINGS

The present invention will be described and understood more readily when considered together with the accompanying drawings, in which:

FIG. 1 is a perspective view of a suspension bracket attachment for use with a paint spray gun in accordance with the present invention;

FIG. 2 is an elevational view of a paint spray gun with a suspension bracket attachment according to a first embodiment of the present invention;

FIG. 3 is an elevational view of a second embodiment of a paint spray gun with a suspension bracket attachment according to the present invention;

FIG. 4 is an exploded view of the method of attachment of the suspension bracket to a spray gun as shown in the embodiment of FIG. 3;

FIG. 5 is an exploded perspective view of the suspension bracket and a portion of the spray gun to which it is attached in the embodiment shown in FIG. 3;

FIG. 6 is a perspective view of the suspension bracket attached to the portion of the spray gun as shown in the embodiment of FIG. 3;

FIG. 7 is an elevational view of a modification of the embodiment shown in FIG. 2 of a paint spray gun with a suspension bracket attachment according to the present invention;

FIG. 8 is a perspective view of a portion of a ladder with the paint spray gun with suspension bracket attachment of FIG. 3 shown suspended therefrom;

FIG. 9 is a perspective view of a portion of a ladder with the paint spray gun with suspension bracket attachment of FIG. 7 shown suspended therefrom;

FIG. 10 is a perspective view of a portion of a scaffold with the paint spray gun with suspension bracket attachment of FIG. 2 shown suspended therefrom;

FIG. 11 is a perspective view of another embodiment of a suspension bracket attachment for use with a paint spray gun in accordance with the present invention; and

FIG. 12 is a perspective view of a paint spray gun with the suspension bracket attachment embodiment shown in FIG. 11.

### DETAILED DESCRIPTION OF THE INVENTION

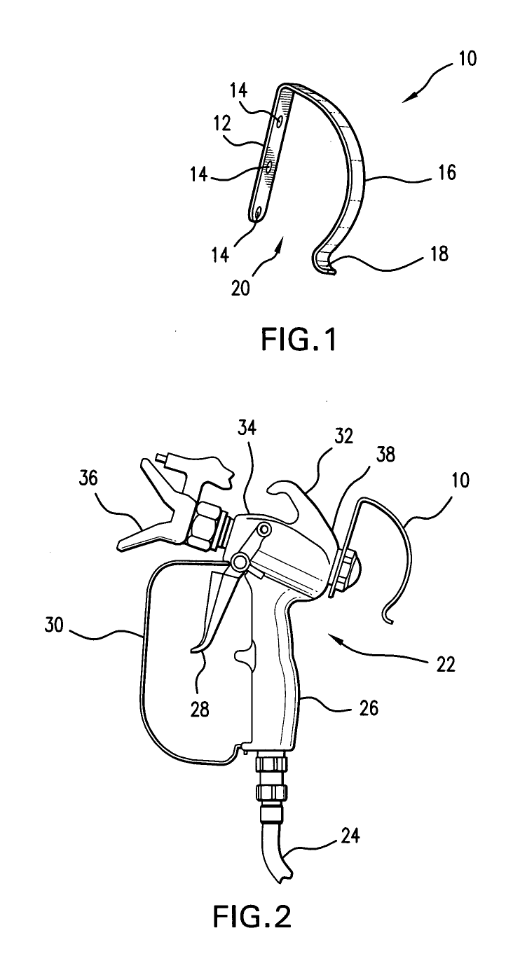

Now turning to the drawings, there is shown in FIG. 1 a suspension bracket attachment, generally designated 10, according to the present invention comprising a generally inverted U-shaped element, wherein one leg thereof is a mounting leg, designated 12, having a plurality of mounting holes 14 therein. The other leg 16 of the U-shaped element generally curves outwardly and downwardly from its connection to mounting leg 12 and terminates in a generally reverse curved lip 18 forming an opening 20 with leg 12.

As clearly seen in FIG. 2, suspension bracket attachment 10 is shown mounted via a mounting hole 14 in mounting leg 12 to a paint spray gun, generally designated 22. Paint spray gun 22 may be an air assisted airless paint spray gun, an electrostatic paint spray gun, a high volume low pressure (HVLP) paint spray gun, an air operated conventional paint spray gun, or an airless or hydraulically operated spray gun. Spray gun 22 as depicted in the drawings is an airless or hydraulically operated spray gun having a high pressure supply hose, designated 24, connected to a handle 26 of the spray gun. Spray gun 22 further includes a trigger 28, a trigger guard 30, a small hook 32 extending from the top of barrel 34 of the spray gun, and spray tip 36 at the forward end of barrel 34. Mounting leg 12 of suspension bracket attachment 10 is secured to the rear end 38 of barrel 34 of spray gun 22 so that the opening 20 of the suspension bracket faces generally downwardly. FIG. 7 shows a modification of the embodiment shown in FIG. 2 wherein mounting leg 12 is mounted to spray gun 22 at the rear end 38 of barrel 34 so that U-shaped suspension bracket 10 is angularly disposed with respect to the longitudinal axis of barrel 34 at an acute angle.

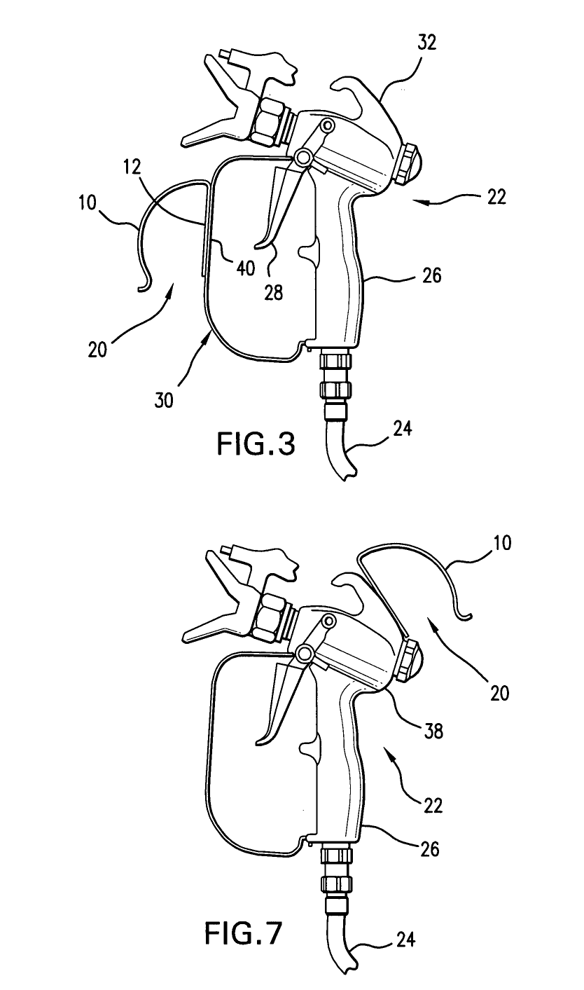

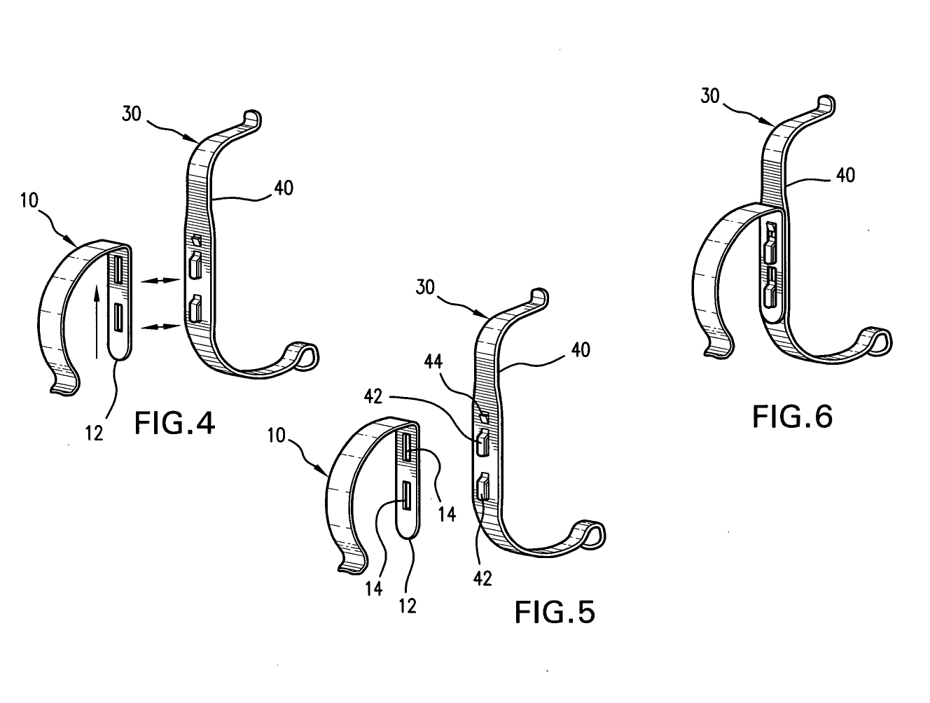

As clearly seen in the preferred embodiment shown in FIG. 3, the trigger guard 30 of spray gun 22 extends from above trigger 28 forwardly and outwardly from the top of handle 26 and beyond the trigger and then downwardly to connect at the bottom of handle 26. The suspension bracket attachment 10 is mounted via its mounting leg 12 to the forward facing downwardly extending portion 40 of trigger guard 30 so that the opening 20 of the suspension bracket attachment 10 is directed downwardly. The preferred method of attachment of the suspension bracket 10 is demonstrated in FIGS. 4 to 6. As clearly seen in FIGS. 4 and 5, the downwardly extending portion 40 of trigger guard 30 is provided with vertically aligned forwardly extending downwardly opening hooks 42 and an arresting tang 44 disposed vertically adjacent to and above one of the hooks 42. The mounting leg 12 of bracket 10 is provided with vertically arranged openings 14 which are aligned with downwardly opening hooks 42 of trigger guard 30. As shown in FIG. 4, suspension bracket 10 is attached to trigger guard 30 by aligning openings 14 with hooks 42 so that hooks 42 enter openings 14. Bracket 10 is then moved upwardly so that the hooks 42 engage with mounting leg 12 of bracket 10, and the arresting tang 44 of downwardly extending portion 40 of the trigger guard engages the upper part of an opening 14 to clamp or lock mounting leg 12 against the trigger guard, as is clearly shown in FIG. 6.

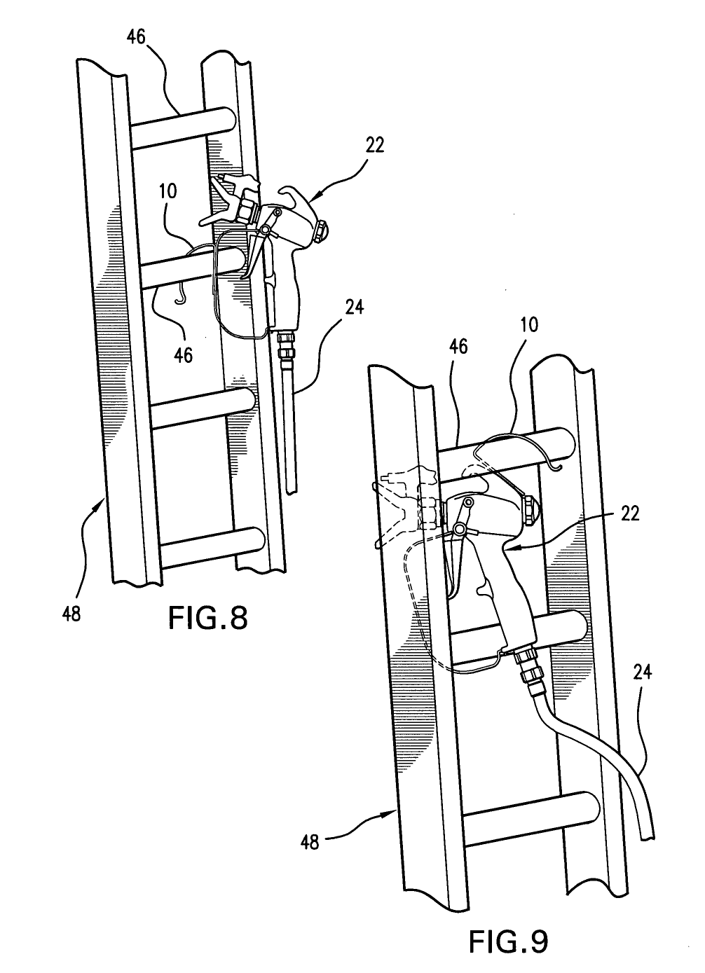

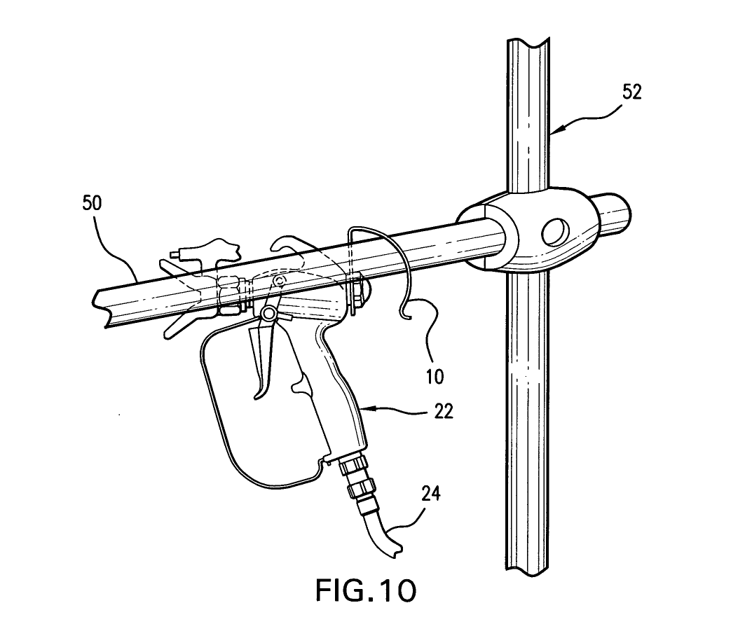

FIGS. 8 to 10 demonstrate the ease with which a paint spray gun with suspension bracket attachment of the present invention can be suspended or hung from a ladder or scaffold by the operator during a painting operation. As clearly seen in FIG. 8, a spray gun 22 with suspension bracket attachment 10 according to the preferred embodiment of FIG. 3 is shown suspended from the rung 46 of a ladder 48. The opening 20 of suspension bracket 10 is large enough to accommodate the passage of rung 46 and permit the suspension of spray gun 22 therefrom. As can be appreciated, the weight of high pressure hose 24 counterbalances the relatively forward fulcrum position of bracket 10 so that the spray gun is substantially vertically suspended on rung 46 from the crook of bracket 10. In FIG. 9, the spray gun 22 with suspension bracket attachment 10 according to the embodiment shown in FIG. 7 is suspended from the rung 46 of ladder 48. Finally, in FIG. 10, the spray gun 22 with suspension bracket attachment 10 according to the embodiment shown in FIG. 2 is suspended from the railing 50 of a scaffold 52. As in the case of FIG. 8, because of the weight of high pressure hose 24 and the fulcrum position of bracket 10, the spray gun is suspended substantially vertically in FIGS. 9 and 10 on the ladder rung 46 or scaffold railing 50 from the crook of suspension bracket 10. It has been found that a suitable dimension for opening 20 of suspension bracket attachment 10 which will adequately permit the passage of a ladder rung or scaffold railing, is about 1.25 inches. It has been further found that a suitable dimension for the widest part of suspension bracket attachment 10 is about 2 inches.

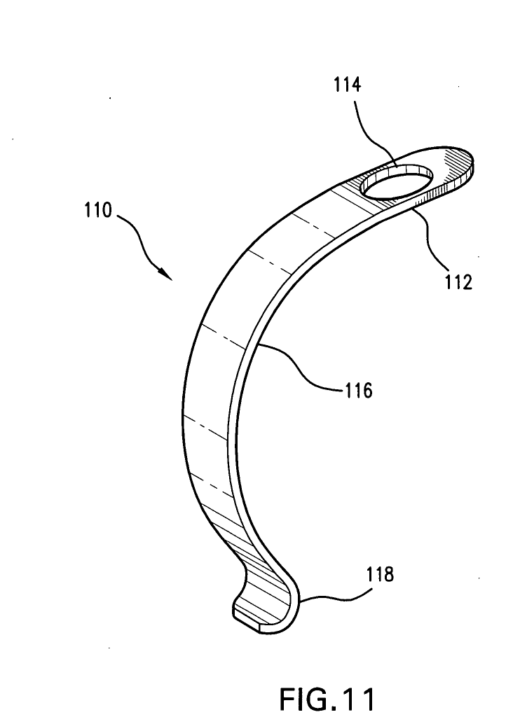

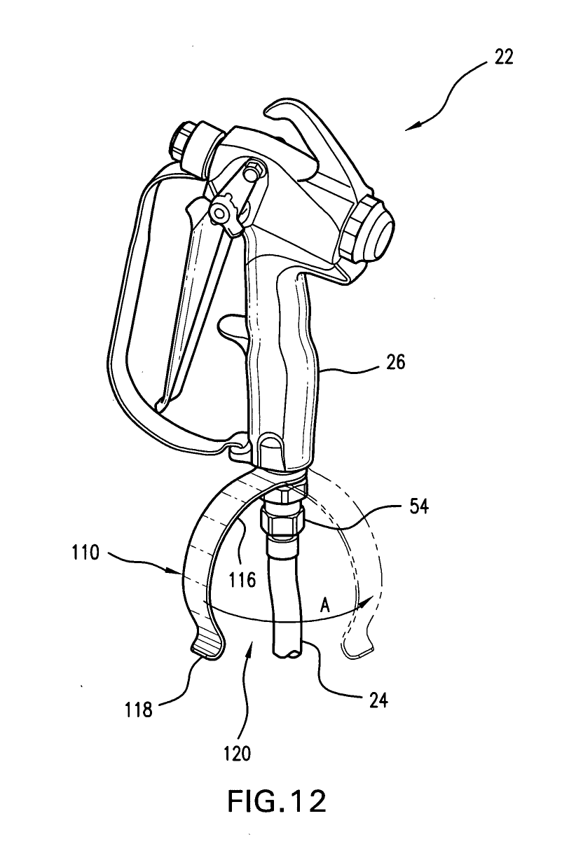

In FIG. 11 there is shown another embodiment of the suspension bracket attachment, designated 110, having a mounting link or leg 112 and a leg 116 which curves outwardly and downwardly from mounting link 112 to terminate in a generally reverse curved lip 118. Mounting link or leg 112 is provided with a mounting hole 114 which permits suspension bracket attachment 110 to be mounted to the bottom of handle 26 of spray gun 22 sandwiched between the swivel coupling 54 of high pressure hose 24 and the handle, as shown in FIG. 12. As clearly seen in FIG. 12, the terminus of curved leg 116, i.e. curved lip 118, forms an opening 120 with depending high pressure hose 24 which is suitable for the passage of a ladder rung, scaffold railing, pipe, bar, etc. to thereby hang the spray gun therefrom. Because it is mounted between the swivel coupling 54 and handle 26, suspension bracket attachment 110 is adapted to rotate 360° about the axis of hose 24 and handle 26 as indicated by the arrow A in FIG. 12.

While several embodiments of the present invention have been shown and described, it will be obvious that many changes and modifications may be made thereto without departing from the spirit and scope of the present invention.

What is claimed is:

1. In a spray gun adapted for atomizing and spraying paint, the spray gun including a barrel portion having a spray tip at a forward end thereof, a handle portion generally depending from said barrel portion, a trigger for controlling the paint spray, a trigger guard extending from near the top of said handle portion outwardly beyond the trigger and then downwardly in front of the trigger to connect to the handle portion near the bottom thereof, the improvement comprising:
a suspension bracket attachment having a mounting leg with at least one mounting hole therein adapted for attachment to said spray gun and a second leg curving generally outwardly and then downwardly from its connection to said mounting leg to terminate in a generally reverse curved lip, the suspension bracket attachment being attached to said spray gun so as to form a generally U-shape defining an opening thereto which generally faces downwardly with respect to said spray gun.

2. The spray gun as defined in claim 1, wherein said suspension bracket attachment is attached to a rear end of said barrel portion of said spray gun by the mounting hole in said mounting leg of said suspension bracket.

3. The spray gun as defined in claim 2, wherein said suspension bracket attachment is attached to said barrel portion so that said suspension bracket is disposed at an acute angle with respect to a longitudinal axis of said barrel portion.

4. The spray gun as defined in claim 1, wherein said suspension bracket attachment is attached to the downwardly extending portion of the trigger guard of said spray gun.

5. The spray gun as defined in claim 4, wherein the downwardly extending portion of the trigger guard includes at least one forwardly extending and downwardly opening hook element and an arresting tang disposed adjacent to and above said hook element, said arresting tang and said hook element cooperating with the mounting hole in said suspension bracket attachment to lock the mounting leg thereof against the downwardly extending portion of the trigger guard.

6. The spray gun as defined in claim 5, wherein the mounting leg of said suspension bracket attachment extends downwardly from the connection to said second leg so that said suspension bracket attachment has a generally U-shaped form.

7. The spray gun as defined in claim 6, wherein the opening into the U-shaped bracket is large enough to allow passage of a ladder rung, a scaffold railing, a pipe, a bar or other structural element.

8. The spray gun as defined in claim 7, wherein the opening into the U-shaped bracket is about 1.25 inches and the widest dimension of the U-shaped bracket is about 2 inches.

9. The spray gun as defined in claim 1, wherein the spray gun includes a hose attached to the bottom of the handle thereof by a swivel coupling and the mounting leg of said bracket attachment is attached at said swivel coupling so that said second leg forms a U-shape with said hose attachment and is rotatable thereabout.

10. The spray gun as defined in claim 9, wherein the opening into the U-shape is large enough to allow passage of a ladder rung or a scaffold railing.

11. The spray gun as defined in claim 9, wherein the opening into the U-shape is about 1.25 inches and the widest dimension of the U-shape is about 2 inches.
